(19) United States
(12) Patent Application Publication
(10) Pub. No.: US 2006/0023610 A1
(43) Pub. Date: Feb. 2, 2006

(54) Optical pickup device and optical disk device

(75) Inventors: Sumitaka Maruyama, Yokohama-shi (JP); Yuuichi Nakamura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/192,404

(22) Filed: Jul. 29, 2005

(30) Foreign Application Priority Data
Jul. 29, 2004 (JP) 2004-222147

(51) Int. Cl. G11B 7/00

(52) U.S. Cl. 369/112.01; 369/44.37

(57) ABSTRACT

An optical pickup device has first emission unit emits first laser beam, second emission unit emits second laser beam whose wavelength is different from that of first laser beam, to same optical axis to first laser beam is emitted, objective lens collects first and second laser beams emitted from first and second emission units and emits collected light to information recording medium, wavefront converting unit arranged on routes of respective reflected lights of first and second laser beams from information recording medium, wavefront converting unit receiving reflected lights of first and second laser beams and selectively wavefront converting at least one of reflected lights, and light receiving unit receives at least one of reflected lights of first and second laser beams having passed through wavefront converting unit, and outputs detection signal corresponding thereto.

### CROSS-REFERENCE TO RELATED APPLICATIONS

This application is based upon and claims the benefit of priority from prior Japanese Patent Application No. 2004-222147, filed Jul. 29, 2004, the entire contents of which are incorporated herein by reference.

### BACKGROUND OF THE INVENTION

1. Field of the Invention

The present invention relates to an optical pickup device and an optical disk device which emit plural laser beams and handle plural kinds of information recording media, and more specifically, to an optical pickup device and an optical disk device which appropriately wavefront convert reflected lights of respective laser beams and receive them.

2. Description of the Related Art

In recent years, an optical disk recording and reproducing device using an optical disk has spread widely, and there is a demand for further higher density of recorded information. An example in which plural kinds of disks such as, for example, a digital versatile disk (DVD) and another disk, are handled with a single optical pickup has been known.

Patent Document 1 (Jpn. Pat. Appln. KOKAI Publication No. 2004-103225) explains a case of reproducing a compact disk (CD) and a DVD by use of a single optical pickup, wherein two laser beams are emitted in parallel while keeping a specified distance, and in the same manner, reflected lights thereof are received in parallel at an light detector while keeping a specified distance.

In the Patent Document 1, two laser beams are radiated by optical axes that are different from each other in design, and the light paths of the reflected lights of the two laser beams are changed toward the light detector. However, the Patent Document does not describe a case where laser beams are combined onto the same optical axis, and the document also fails to describe wavefront conversion to ultrafine displacement of reflected lights in that case, which has been a problem in the prior art.

### BRIEF SUMMARY OF THE INVENTION

An embodiment of the present invention is an optical pickup device comprising: a first emission unit which emits a first laser beam; a second emission unit which emits a second laser beam whose wavelength is different from that of the first laser beam, to the same optical axis to which the first laser beam is emitted; an objective lens which collects the first and second laser beams emitted from the first and second emission units, and emits the collected light to an information recording medium; a wavefront converting unit arranged on routes of respective reflected lights of the first and second laser beams from the information recording medium, the wavefront converting unit receiving the reflected lights of the first and second laser beams and selectively wavefront converting at least one of the reflected lights; and a light receiving unit which receives at least one of the reflected lights of the first and second laser beams having passed through the wavefront converting unit, and outputs a detection signal corresponding thereto.

### BRIEF DESCRIPTION OF THE SEVERAL VIEWS OF THE DRAWING

FIG. 1 is an explanatory view showing an example of an optical pickup device according to one embodiment of the present invention;

FIG. 2 is an explanatory view showing an example of an wavefront converting unit and an optical detecting unit which handle reflected lights of the optical pickup device according to the embodiment of the invention;

FIG. 3 is an explanatory view showing another example of an optical pickup device according to one embodiment of the invention;

FIG. 4 is an explanatory view showing another example of a wavefront converting unit and an optical detecting unit which handle reflected lights of the optical pickup device according to the embodiment of the invention;

FIG. 5 is an explanatory view showing still another example of an optical pickup device according to one embodiment of the invention;

FIG. 6 is an explanatory view showing still another example of a wavefront converting unit and an optical detecting unit which handle reflected lights of the optical pickup device according to the embodiment of the invention;

FIG. 7 is an explanatory view showing further another example of the wavefront converting unit and the optical detecting unit which handle reflected lights of the optical pickup device according to the embodiment of the invention;

FIG. 8 is a view showing an example of an objective lens in which a relative inclination by plural laser beams is shown;

FIG. 9 is a view showing an example of relation between reflected lights by plural laser beams and a detecting unit; and

FIG. 10 is a block diagram showing an example of a configuration of an optical disk device using the optical pickup device according to the embodiment of the invention.

### DETAILED DESCRIPTION OF THE INVENTION

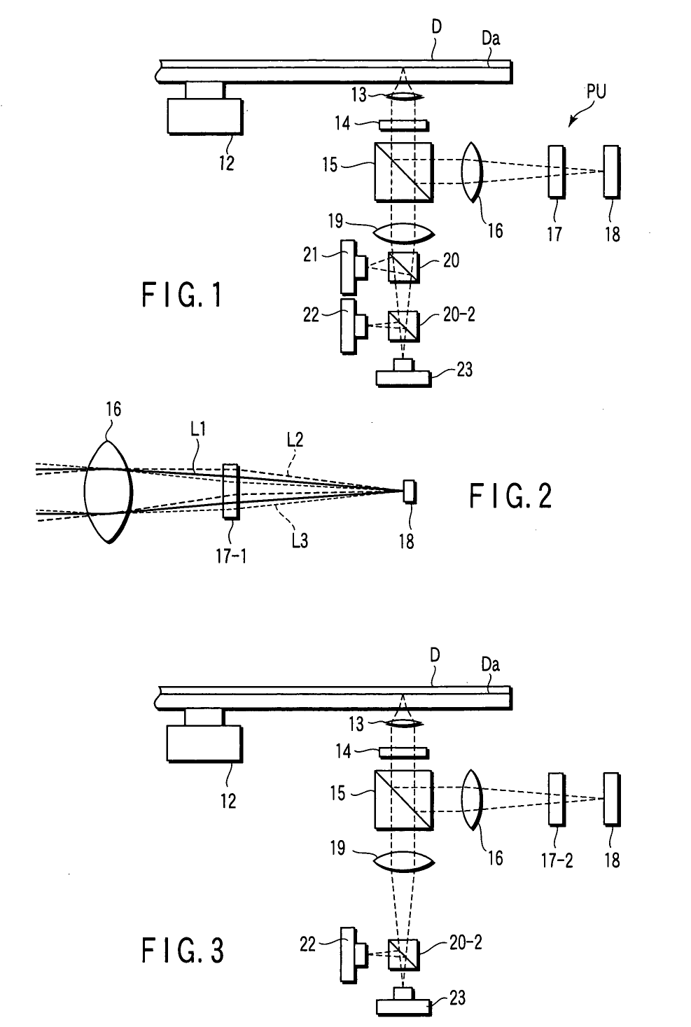

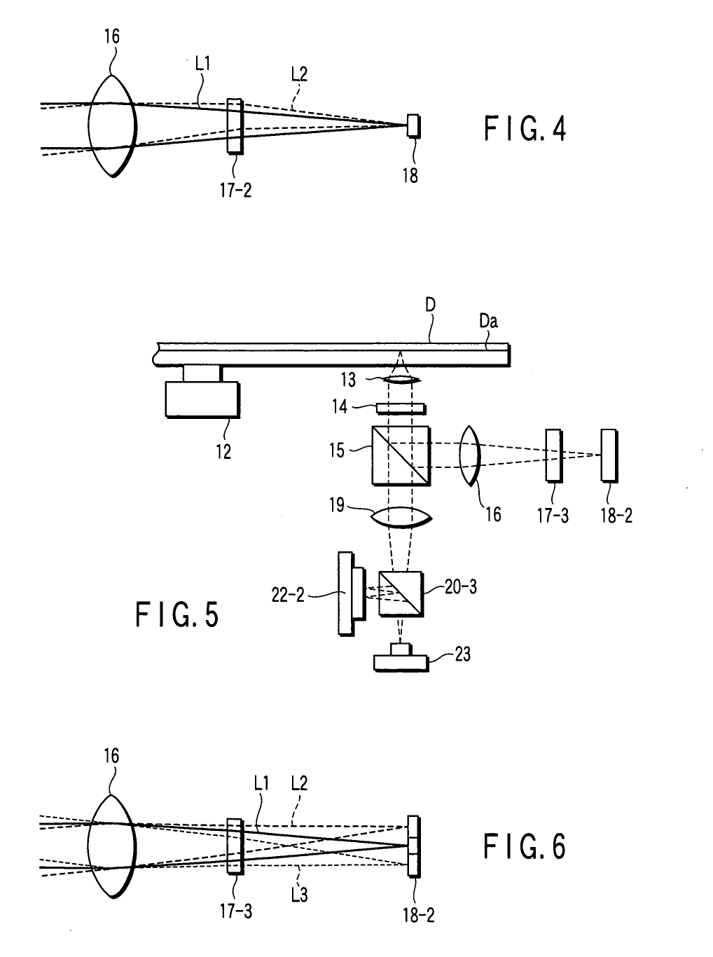

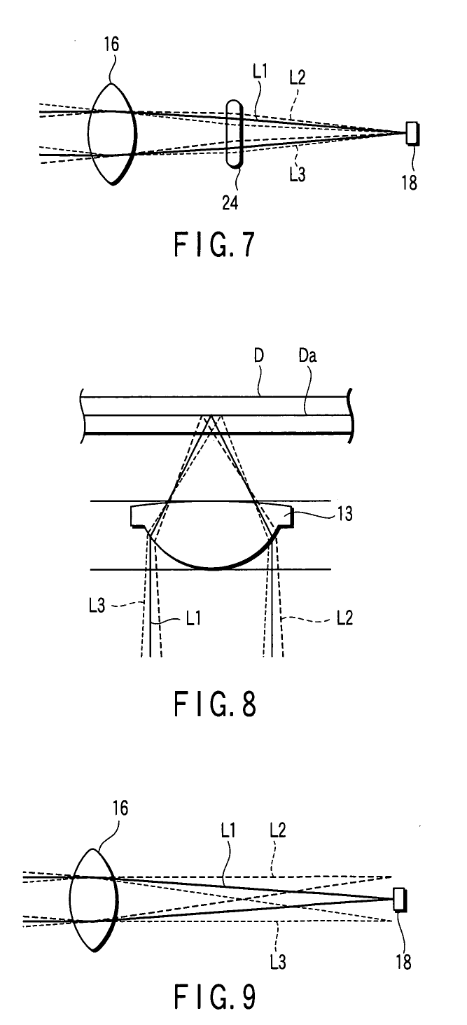

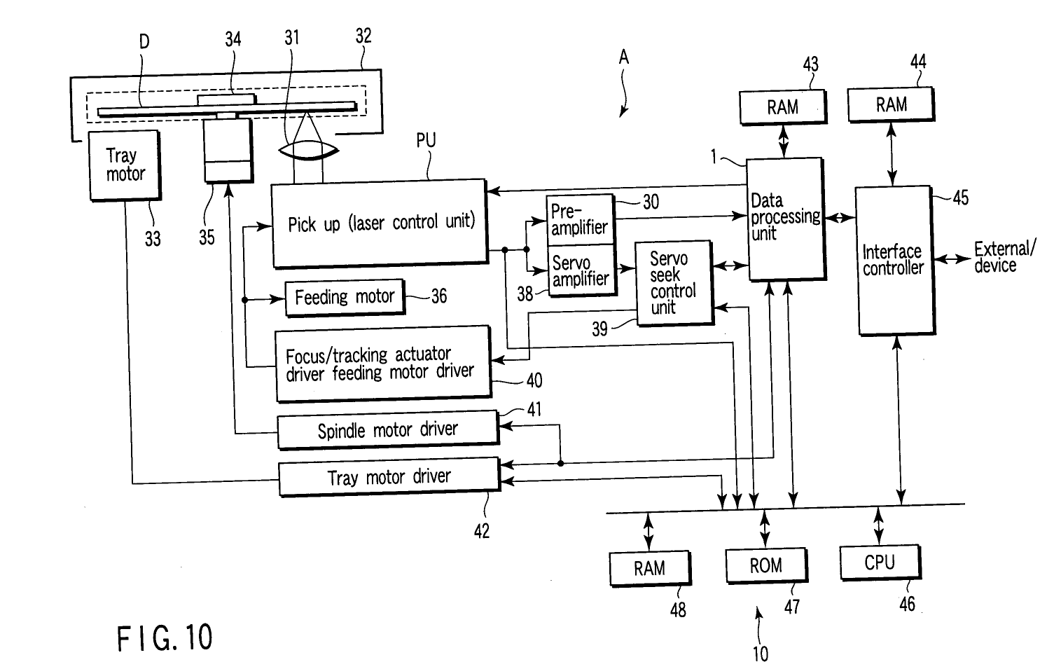

One embodiment of an optical pickup device according to the invention and an optical disk device to which the optical pickup device is applied will be illustrated in more details with reference to the accompanying drawings hereinafter. FIG. 1 is an explanatory view showing an example of an optical pickup device according to one embodiment of the invention. FIG. 2 is an explanatory view showing an example of an wavefront converting unit and an optical detecting unit which handle reflected lights of the optical pickup device according to the embodiment of the invention. FIG. 3 is an explanatory view showing another example of an optical pickup device according to one embodiment of the invention. FIG. 4 is an explanatory view showing another example of a wavefront converting unit and an optical detecting unit which handle reflected lights of the optical pickup device according to the embodiment of the invention. FIG. 5 is an explanatory view showing still other example of an optical pickup device according to one embodiment of the invention. FIG. 6 is an explanatory view showing still other example of a wavefront converting unit and an optical detecting unit which handle reflected lights of the optical pickup device according to the embodiment of the invention. FIG. 7 is an explanatory view showing further other example of the wavefront converting unit and the optical detecting unit which handle reflected lights of the optical pickup device according to the embodiment of the invention. FIG. 8 is a view showing an example of an objective lens in which a relative inclination by plural laser beams is shown. FIG. 9 is a view showing an example of relation between reflected lights by plural laser beams and a detecting unit. FIG. 10 is a block diagram showing an example of a configuration of an optical disk device using the optical pickup device according to the embodiment of the invention.

<Optical Pickup Device>

An optical pickup device mainly applied to the optical disk device according to the invention will be illustrated in more details with reference to the accompanying drawings hereinafter.

In the present embodiment, a phase change type optical disk is described. However, the invention may be applied widely to an optical pickup for information recording medium having a light transmission layer, and an information recording medium targeted for recording and reproduction may be a replay exclusive optical disk, a magneto optical disk, or an optical card.

An optical pickup device PU according to the invention, as shown in FIG. 1, has an information recording medium such as an optical disk D, and a spindle motor 12 which rotates the information recording medium, and the optical pickup device PU rotates the information recording medium at a predetermined rotation speed. Further, the optical disk D to/from which the optical pickup head PU records/reproduce information has a light transmission layer for protecting a surface Da of a recording and reproducing layer.

Further, explanation will be given for a case where the optical pickup device PU has three light sources with different wavelengths, but it is similarly applicable to a case of having four or more light sources with different wavelengths. The optical pickup device PU has a light source 21 (first wavelength), a light source 22 (second wavelength), and a light source 23 (third wavelength) having different wavelengths. Herein, as one embodiment of the respective light sources, the first wavelength may be around 405 nm (high density DVD), the second wavelength may be around 660 nm (DVD), and the third wavelength may be around 785 nm (CD), but the invention is not limited thereto. For example, it is also preferable that the first laser beam is 440 nm or less in wavelength, the second laser beam is 600 to 700 nm in wavelength, and the third laser beam is 700 nm or more in wavelength.

Further, in the optical pickup device PU, laser beams emitted from dichroic prisms 20, 20-2 are combined onto a substantially same optical axis by the dichroic prisms 20, 20-2. In addition, in the optical pickup device PU, the laser beam becomes parallel light by a collimator lens 19, passes through a polarizing beam splitter 15, and a λ/4 plate 14 and is collected by an objective lens 13, and the laser beam is incident into the optical disk D that is rotated by the spindle motor 12. The light incident from the optical disk surface is collected onto the surface Da of the recording and reproducing layer. The light reflected by the surface Da of the recording and reproducing layer, now on the reverse, passes through the objective lens 13, and the λ/4 plate 14, and then is reflected by the polarizing beam splitter 15. The reflected light is collected by a condensing lens 16, and the wave-length thereof is identified by a wavefront converting unit 17 having wavelength selection property, so that an optical axis error of two reflected waves is corrected, and the light is received by, for example, a light detector 18.

Note that one example of a specific configuration of the wavefront converting unit 17 is, for example, a hologram which is diffracted by a predetermined diffraction ratio (wavefront conversion ratio) to only a specific wavelength. When the wavefront converting unit 17 is a hologram, it has plural layers which selectively wavefront convert reflected wave of a predetermined wavelength, and these plural layers form one hologram. In this hologram, the respective layers are diffracted by exclusive diffraction ratios (wavefront conversion ratios) with respect to plural kinds of wavelengths, thereby making it possible to wavefront convert plural laser beams of different wavelengths arbitrarily, and separate them.

Namely, three optical axes of the lights emitted from the objective lens 13 and entering the optical disk D substantially coincide with one another, theoretically. However, as shown in FIG. 9, there are errors among the positions of the light source 21 of the first laser beam L1, the light source 22 of the first laser beam L2, and the light source 23 of the first laser beam L3, owing to, for example, assembly adjustment errors or the like, and therefore, the three optical axes may not meet in some cases at the stage of going out from the objective lens 13 as shown in FIG. 8, which is called relative inclination. If the relative inclination exists, the light collected by the condensing lens 16 splits into the laser beam L2 which is correctly incident into the light detector 18, and the laser beams L1 and L3 which are not correctly incident into the light detector, as shown in FIG. 9.

Accordingly, as shown in FIG. 2, the wavefront converting unit 17 having wavelength selection property is inserted between the condensing lens 16 and the light detector 18, thereby laser beams are selectively converted on the basis of wavelengths thereof. As one example thereof, the wavefront converting unit 17 allows the laser beam L1 of the first wavelength that goes through the center to go through as is without changing the wavefront thereof.

On the other hand, the wavefront conversion is performed to the wavelengths of the laser beam L2 and the laser beam L3, and one of diffraction conversion function and light condensing function, or both of the functions are applied, thereby making it possible to lead the laser beams to the light detector 18. In this manner, in an optical pickup having three different wavelengths that are theoretically on the substantially same optical axis, it is possible to lead laser beams onto the light detector by adjusting the diffraction ratio of the wavefront converting unit 17 or light collection angles or directions even in the case where there is relative inclination arising from assembly adjustment errors.

Note that, in the embodiment shown in FIGS. 1 and 2, the first wavelength whose wavefront is not converted is supposed to be the shortest wavelength, and the second and third wavelengths are wavefront converted. This is because in the case where the first wavelength is supposed to be around 405 nm, the second wavelength is supposed to be around 660 nm, and the third wavelength is supposed to be around 785 nm, the difference between the second wavelength and the third wavelength is small with respect to the first wavelength, and therefore, it is estimated that there are few errors on the light detector owing to the difference in relative inclination between the second wavelength and the third wavelength. Accordingly, with regard to which wavelength the wavefront is to be converted to, other combinations may be used.

(Case of Two Laser Beams)

Next, an embodiment of an optical pickup device PU in the case of two laser beams will be explained with reference to FIGS. 3 and 4 hereinafter. Namely, the laser beam is not limited to, for example, the embodiment in FIG. 1, but two laser beams may be employed, and may be set appropriately and arbitrarily, such as, for example, setting the first wavelength around 405 nm (high density DVD) and the second wavelength around 660 nm (DVD), or alternatively, setting the first wavelength around 660 nm (DVD) and the second wavelength around 785 nm (CD). In FIG. 4, one example of a wavefront converting unit and a light detecting unit in this case is shown.

(Two Laser Light Sources Stored in One Cartridge)

Next, as shown in FIG. 5, it is preferable to store two laser light sources in one cartridge 22-2. In this case, it is also preferable to use one dichroic prism 20-3 to two laser light sources. In this manner, it is possible to save the mechanical space of the pickup device PU and further improve its integration density.

(Wavefront Converting Unit for Light Receiving Unit Separated per Laser Beam)

Next, a wavefront converting unit having a light receiving unit separated per laser beam will be explained in details with reference to FIG. 6. Namely, it is preferable to diffract the respective laser beams L1, L2, and L3 by respectively different diffraction ratios (wavefronts) (or collect by a lens) according to wavelengths of the respective laser beams L1, L2, and L3 as shown in FIG. 6, and thereby lead the laser beams L1, L2, and L3 respectively to their exclusive light receiving sections in a light receiving unit 18-2. In this manner, the light receiving unit 18-2 is capable of independently detecting the respective laser beams L1, L2, and L3. Accordingly, for example, it is possible to emit the laser beams L1, L2, and L3 simultaneously from laser light sources 21, 22, and 23 (or laser light sources 22-2, and 23 shown in FIG. 5), and thereby, it is also possible to detect tilts from plural laser beams, for example.

(Wavefront Conversion by Lens)

Next, explanation will be given for an embodiment of the case where, in the wavefront converting unit, a desired wavefront conversion is carried out by a lens, like a wavefront converting unit 24 shown in FIG. 7. Namely, according to which laser beam is to be changed and how much its direction is to be changed, a lens is selected according to the light collection ratio of the laser beam to be deflected, and grooves are made appropriately in the lens according to wavelength of the laser beam to be collected, so that the wavefront converting unit 24 by a lens is realized, and has functions similar to those of the above-mentioned hologram.

As explained above, the wavefront converting unit according to one embodiment of the invention can be realized by various configurations, and consequently, plural laser beams can be emitted from the laser light sources 21, 22, 23 simultaneously.

<Optical Disk Device>

Next, as one example of an information recording and reproducing device using the above-mentioned optical pickup device, an optical disk device will be explained hereinafter.

(Basic Configuration of Optical Disk Device)

In FIG. 10, an optical disk device A using the optical pickup device according to the invention is for recording data to or reproducing data from an optical disk D. The optical disk device A has a tray 32 which transfers the optical disk D contained in a disk cartridge; a motor 33 which drives the tray; a damper 34 which holds the optical disk D; and a spindle motor 12 which rotates the optical disk D held by the clamper at a predetermined rotation speed. Further, a CPU 46 which controls the entire operation as a control unit, a ROM 47 which stores basic programs of the control operation and the like, and a RAM 48 which stores control programs, application data and the like in a rewritable manner are connected to the optical disk device via a control bus. Furthermore, in connection to control units such as the CPU 46, a feeding motor 36 which transfers a pickup PU, a focus/tracking actuator driver/feeding motor driver 40 which controls the focus and tracking of the pickup, as well as a spindle motor driver 41 which drives the spindle motor 12, and a tray motor driver 42 which drives the tray motor are arranged, respectively.

Moreover, the optical disk device has a pre-amplifier 30 connected to a pickup head PU, for amplifying detection signals, a servo amplifier 38, and a servo seek control unit 39 which supplies seek signals for seek operation to drivers. There are also provided: a data processing unit 1 connected to the pickup head PU, the pre-amplifier 30, the servo seek control unit 39 and the like, for processing detection signals and recording signals; and a RAM 43 for storing data for use in various processes. In order to send/receive signals from the data processing unit 1 to/with an external device, an interface controller 45 is arranged together with a RAM 44.

(Basic Operation of Optical Disk Device)

The optical disk device to which the optical pickup device having such a configuration according to the invention carries out a reproducing process and a recording process of an optical disk as follows. Namely, when the optical disk D is loaded onto the optical disk device A, control information of the optical disk D recorded in a control data zone in an emboss data zone of a read-in area of the optical disk D is read by use of the pickup head PU and the data processing unit 1, and the read information is supplied to the CPU 46.

In the optical disk device A to which the optical pickup device according to the invention is applied, a laser beam, being energized by the LD light sources 21 to 23, is generated under the control of the CPU 46, on the basis of operation information by user's operations, control information of the optical disk D recorded in the control data zone in the optical disk, the current status and the like.

The generated laser beam is converged by the objective lens 13, and is emitted to the recording area of the optical disk D. As a result, data is recorded in the recording area of the optical disk D (generation of mark row: data is recorded to the optical disk D by an interval between variable-length marks, and the length of each variable-length mark), or alternatively, light of intensity corresponding to stored data is reflected and detected, and the data is reproduced.

In FIG. 10, the settings of the control unit included in the pickup head PU are set by the data processing unit 1, and the settings are different depending on reproduction power for obtaining a reproduction signal RF, recording power for recording data and deleting power for deleting data. The laser beam has different levels of power respectively for the reproduction power, the recording power and the deleting power, and a semiconductor laser unit is energized by the laser control unit such that laser beams of the respective powers are generated.

The laser control unit is composed of a resistor and a transistor (not shown), and power source voltage is applied to the resistor, the transistor and a semiconductor laser as the semiconductor laser unit. In this manner, amplification factors are different depending on base current of the transistor, and different currents flow in a semiconductor laser oscillator, so that laser beams of different intensities are generated.

In addition, the optical disk D is transferred in the device directly or in a state of being contained in the disk cartridge by the tray 32 such that the optical disk D is arranged to face the objective lens 13. The tray motor 33 for driving the tray 32 is arranged in the device. Further, the loaded optical disk D is rotatably held on the spindle motor 12 by the clamper 34, and is rotated by the spindle motor 12 at a predetermined rotation speed.

The pickup head PU has the light detector 18 which detects a laser beam in the inside thereof. The light detector 18 detects a laser beam that is reflected by the optical disk D and returned via the objective lens 13.

The detection signal is supplied to the pre-amplifier 30 and the servo amplifier 34. From the pre-amplifier 30, signals for reproducing data of the header portion and for reproducing data of the recording area are output to the data processing unit 1. Track error signals from the servo amplifier 34 are output to the servo seek control unit 39.

Herein, a method of optically detecting a focus displacement amount includes an astigmatism method and the above-mentioned knife edge method, but another focus control method may be also applied to the invention in the same manner.

The optical disk D has a spiral or concentric track, and information is recorded onto the track. A light collection spot is traced along the track, and information is reproduced, or recorded or deleted. In order to cause the light collection spot to trace along the track stably, it is necessary to optically detect the relative positional displacement of the track and the light collection spot.

By the track control, tracking signals and feeding signals are sent from the servo seek control unit 39 to the lens actuator driver 11 and the tracking actuator driver and feeding motor driver 40, and tracking servo control is carried out by the driver 40. Further, energizing signals are supplied from the driver 40 to the motor 36 according to access signals, and thereby transfer of the pickup head PU is controlled.

Further, the servo seek control unit 39 is controlled by the data processing unit 1. For example, an access signal is supplied from the data processing unit 1 to the servo seek control unit 39, and a feeding signal is generated.

In addition, the spindle motor driver 41 and the tray motor driver 42 are controlled by the control signal from the data processing unit 1, the spindle motor 12 and the tray motor 33 are energized, the spindle motor 12 is rotated at the predetermined rotation speed, and the tray motor 33 controls the tray appropriately.

The reproduction signal RF corresponding to the data of the header portion supplied to the data processing unit 1 is supplied to the CPU 46. Thereby, the CPU 46 determines a sector number as an address of the header portion by the reproduction signal RF, and makes a comparison with a sector number as an address to be accessed (record data or reproduce recorded data)

With regard to the reproduction signal RF corresponding to the data of the recording area supplied to the data processing unit 1, necessary data is stored into the RAM 48, the reproduction signal RF is processed by the data processing unit 1 and supplied to the interface controller 45, and a reproduction processing signal is supplied to an external device such as, for example, a personal computer.

As explained heretofore, by applying the optical pickup device according to the invention, when positioning one laser beam to the light receiving unit with respect to reflected waves of plural laser beams emitted onto the same optical axis, even the remaining reflected wave is guided precisely to the light receiving unit by the wavefront converting unit having wavelength selection property, in order to correct an adjustment error of the routes of reflected waves of two laser beams. Accordingly, highly reliable light receiving process is carried out, and secure recording process and reproducing process are realized.

Namely, in the optical pickup device according to one embodiment of the invention, when positioning one laser beam to the light receiving unit with respect to reflected waves of plural laser beams emitted onto the same optical axis, the routes of reflected waves of two laser beams do not completely meet with each other, and a slight displacement is left in the other laser beam as an adjustment error, but, the remaining laser beam is wavefront converted, and thereby guided to the same light receiving unit. In this case, the wavefront converting unit has wavelength selection property, and corrects the adjustment error between reflected waves of two laser beams by a desired wavefront conversion ratio.

According to various embodiments described above, those skilled in the art may realize the present invention. Further, those skilled in the art may easily conceive various modifications from these embodiments, and may apply them to various embodiments even without having innovative capabilities. Therefore, the invention includes a wide scope of forms without departing from the principle disclosed herein or novel characteristics thereof, and is not limited to the above-mentioned embodiments.

What is claimed is:

1. An optical pickup device comprising:
a first emission unit which emits a first laser beam;
a second emission unit which emits a second laser beam whose wavelength is different from that of the first laser beam, to the same optical axis to which the first laser beam is emitted;
an objective lens which collects the first and second laser beams emitted from the first and second emission units, and emits the collected light to an information recording medium;
a wavefront converting unit arranged on routes of respective reflected lights of the first and second laser beams from the information recording medium, the wavefront converting unit receiving the reflected lights of the first and second laser beams and selectively wavefront converting at least one of the reflected lights; and
a light receiving unit which receives at least one of the reflected lights of the first and second laser beams having passed through the wavefront converting unit, and outputs a detection signal corresponding thereto.

2. An optical pickup device according to claim 1, wherein the first laser beam and the second laser beam are emitted onto the same optical axis by use of a prism.

3. An optical pickup device according to claim 1, wherein the wavefront converting unit is a hologram.

4. An optical pickup device according to claim 1, wherein the wavefront converting unit has wavelength selection property that selectively wavefront converts laser beams according to wavelengths thereof.

5. An optical pickup device according to claim 1, wherein the wavefront converting unit wavefront converts the first laser beam and the second laser beam at respectively different wavefront conversion ratios.

6. An optical pickup device according to claim 1, further comprising a third emission unit which emits a third laser beam whose wavelength is different from those of the first and second laser beams, wherein
the wavefront converting unit wavefront converts at least one of the first to third laser beams, and
the light receiving unit receives at least one of reflected lights of the first to third laser beams having passed through the wavefront converting unit and outputs a detection signal.

7. An optical pickup device according to claim 1, wherein the wavefront converting unit does not wavefront convert the first laser beam, but wavefront converts only the second and third laser beams.

8. An optical pickup device according to claim 1, wherein the first laser beam is 440 nm or less in wavelength, the second laser beam is 600 to 700 nm in wavelength, and the third laser beam is 700 nm or more in wavelength.

9. An optical pickup device according to claim 1, wherein the first emission unit and the second emission unit are arranged in the same package.

10. An optical pickup device according to claim 1, wherein the light receiving unit receives the first and second laser beams at plural different light receiving sections.

11. An optical disk device comprising:
a first emission unit which emits a first laser beam;
a second emission unit which emits a second laser beam whose wavelength is different from that of the first laser beam;
an objective lens which collects the first and second laser beams emitted from the first and second emission units, and emits the collected light to an information recording medium;
a wavefront converting unit arranged on routes of respective reflected lights of the first and second laser beams from the information recording medium, the wavefront converting unit receiving the reflected lights of the first and second laser beams and selectively wavefront converting at least one of the reflected lights;
a light receiving unit which receives at least one of the reflected lights of the first and second laser beams having passed through the wavefront converting unit, and outputs a detection signal corresponding thereto; and
a processing unit which carries out a recording process or a reproducing process to the information recording medium on the basis of the detection signal received by the light receiving unit.

12. An optical disk device according to claim 11, wherein the first laser beam and the second laser beam are emitted onto the same optical axis by use of a prism.

13. An optical disk device according to claim 11, wherein the wavefront converting unit is a hologram.

14. An optical disk device according to claim 11, wherein the wavefront converting unit has wavelength selection property that selectively wavefront converts laser beams according to wavelengths thereof.

15. An optical disk device according to claim 11, wherein the wavefront converting unit wavefront converts the first laser beam and the second laser beam at respectively different wavefront conversion ratios.

16. An optical disk device according to claim 11, further comprising a third emission unit which emits a third laser beam whose wavelength is different from those of the first and second laser beams, wherein
the wavefront converting unit wavefront converts at least one of the first to third laser beams, and
the light receiving unit receives at least one of reflected lights of the first to third laser beams having passed through the wavefront converting unit and outputs a detection signal.

17. An optical disk device according to claim 11, wherein the wavefront converting unit does not wavefront convert the first laser beam, but wavefront converts only the second and third laser beams.

18. An optical disk device according to claim 11, wherein the first laser beam is 440 nm or more in wavelength, the second laser beam is 600 to 700 nm in wavelength, and the third laser beam is 700 nm or less in wavelength.

19. An optical disk device according to claim 11, wherein the first emission unit and the second emission unit are arranged in the same package.

20. An optical disk device according to claim 11, wherein the light receiving unit receives the first and second laser beams at plural different light receiving sections.
